(19) United States
(12) Patent Application Publication
(10) Pub. No.: US 2003/0121359 A1
(43) Pub. Date: Jul. 3, 2003

(54) Motorcycle handgrip

(76) Inventor: George Pacheco, Union City, CA (US)

Correspondence Address: Cindy A. Lynch, BURNS, DOANE, SWECKER & MATHIS, L.L.P., P.O. Box 1404, Alexandria, VA, 22313-1404, US

(21) Appl. No.: 10/323,513

(22) Filed: Dec. 18, 2002

Related U.S. Application Data
(60) Provisional application No. 60/341,946, filed on Dec. 18, 2001.

(51) Int. Cl. B62K 21/26

(52) U.S. Cl. 74/551.9

(57) ABSTRACT

A motorcycle handgrip for a motorcycle handlebar is provided which is securely retained on the handlebar without the need for set screws. The motorcycle handgrip includes a handle having a tapered inner surface and a threaded inner surface, a collet having a tapered outer surface and a slot, and a locking nut having a threaded outer surface and means for tightening the locking nut into the handle to secure the handle to a motorcycle handlebar.

### REFERENCE TO RELATED APPLICATIONS

This application claims priority to U.S. Provisional Application Serial No. 60/341,946 filed Dec. 18, 2001, which is hereby incorporated by reference in its entirety.

### FIELD OF THE INVENTION

The invention relates to a motorcycle handgrip, and more particularly, the invention relates to a handgrip for a motorcycle handlebar which is securely retained on the handlebar without the need for set screws.

### DESCRIPTION OF THE RELATED ART

The known motorcycle handgrips are secured to the handlebars by set screws which protrude from the handgrip. These set screws function to secure the handgrip onto the handlebar but destroy the aesthetics of the handgrip.

In accordance with one aspect of the present invention, a motorcycle handgrip comprising of a handle having a tapered inner surface and a threaded inner surface, a collet having a tapered outer surface and a slot, and a locking nut having a threaded outer surface and means for tightening the locking nut into the handle to secure the handle to a motorcycle handlebar.

### SUMMARY OF THE INVENTION

The present invention relates to a handgrip for a motorcycle handlebar which is attached to the motorcycle handlebar by a collet and threaded locking nut without the need for any set screws or other members protruding from the handgrip.

### BRIEF DESCRIPTION OF THE DRAWING FIGURES

The invention will now be described in greater detail with reference to the preferred embodiments illustrated in the accompanying drawings, in which like elements bear like reference numerals, and wherein:

FIGS. 1A and 1B are a top view and a side view of the locking nut.

FIGS. 2A and 2B are a top view and a side view of the collet.

FIG. 3 is a side view partially cut away of the handle.

FIG. 4 is an exploded side view of the handgrip assembly.

FIG. 5 is a top view of the tightening tool.

### DETAILED DESCRIPTION OF THE INVENTION

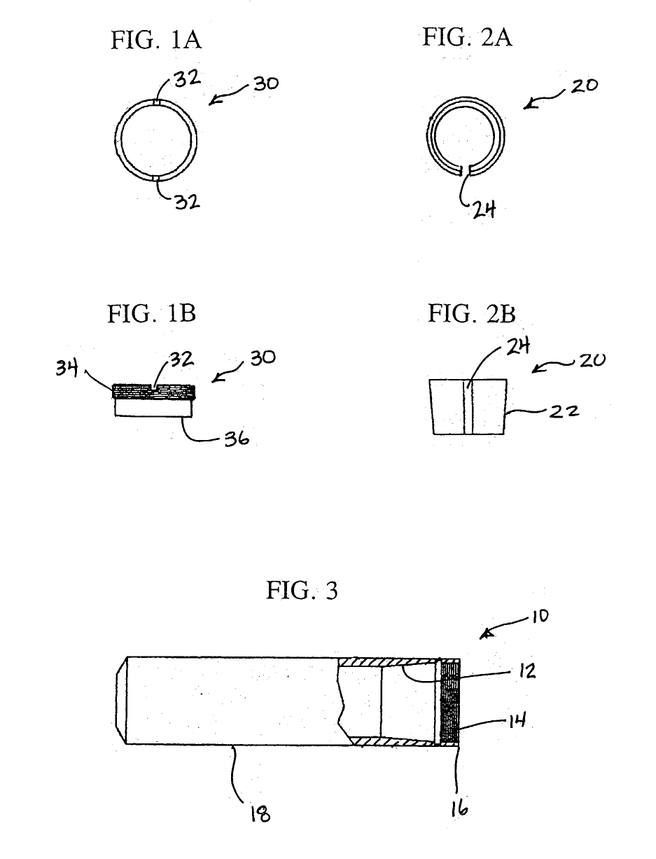

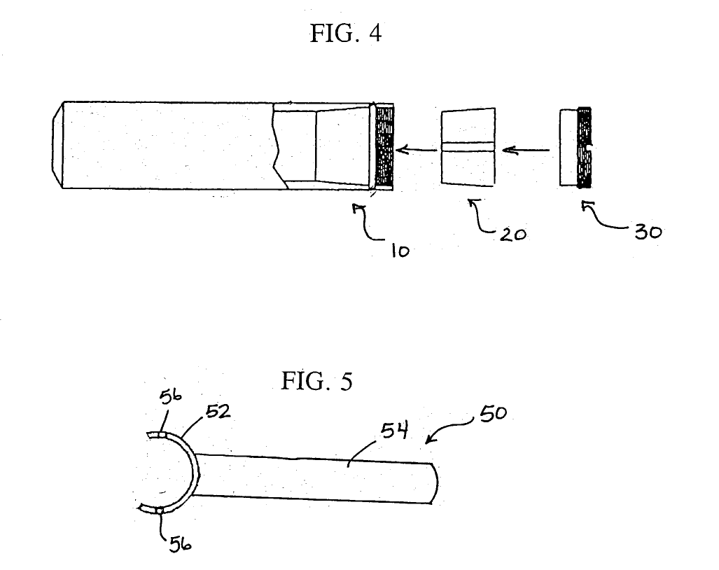

The handgrip assembly of the present invention includes a locking nut 30 of FIGS. 1A and 1B with a threaded outer surface 34, two or more radially oriented slots 32, and an advancing surface 36 for advancing a collet 20.

The collet 20 of FIGS. 2A and 2B includes a tapered outer surface 22 having a taper angle measured between an axis of the collet and the outer surface of about 1 to about 10 degrees, preferably about 3 to about 6 degrees and more preferably about 4.5 degrees. The collet 20 also includes a longitudinal slot 24 for allowing axial compression of the collet. The collet 20 preferably has a length of about 0.25 to about 2 inches, more preferably about 0.6 to about 1.0 inches.

FIG. 3 illustrates a handgrip 10 having an internal tapered surface 12 which extends for a distance which is preferably approximately the length of the collet or larger. The handgrip 10 has a threaded inner surface 14 substantially adjacent the tapered inner surface 12 and located adjacent an open 16 end of the handgrip. The handgrip 10 has an outer surface 18 which may be contoured, padded, or otherwise designed in a manner to accommodate a motorcycle rider's hand. The handgrip 10 has a hollow interior to accommodate an end of a handlebar.

The handgrip assembly is assembled by placing the collet 20 of FIGS. 2A and 2B into the handgrip 10 of FIG. 3 with the tapered outer surface 22 of the collet abutting the tapered inner surface 12 of the handgrip. The locking nut 30 is then threaded into the handgrip 10 without tightening. The handgrip assembly is placed over a motorcycle handlebar and is tightened by a tightening tool 50 shown in FIG. 5.

The tightening tool 50 has a C-shaped tool body or fork 52 and a handle 54. The fork 52 of the tightening tool has protrusions 56 extend from the C-shaped body in a direction parallel to an axis of the body. The protrusions 56 fit into the slots 32 in the locking nut 30. The tightening tool 50 is used to tighten the threaded locking nut 30 into the handgrip 10 to force the collet 20 inner surface into tight mating engagement with the handgrip. As the collet 20 is pushed into the handgrip, a slit 24 in the collet allows the collet to be compressed to grip the outer surface of the handlebar. The collet 20 securely grips the handlebar and prevents the handgrip assembly from being removed from the handlebar without the need for set screws or other protruding external locking devices. The tightening tool 50 may also be used to remove the handgrip assembly.

The design of the handle itself can be any desired design such as an ergonomic grip. The number of slots 32 in the locking nut 30 and protrusions on the associated tightening tool may be varied. The dimensions and configurations of the parts may also be varied without departing from the invention.

The design of the handgrip assembly of the present invention provides a secure connection of the handgrip 10 to the handlebar without the need for a set screw or any other fastener which extends radially beyond the handgrip. In addition, the design of the handgrip assembly preferably provides a locking nut which does not protrude substantially in the axial direction from beneath the handgrip.

While the invention has been described in detail with reference to the preferred embodiments thereof, it will be apparent to one skilled in the art that various changes and modifications can be made and equivalents employed, without departing from the present invention.

What is claimed is:

1. A motorcycle handgrip comprising:
a handle having a tapered inner surface and a threaded inner surface;
a collet having a tapered outer surface and a slot;
a locking nut having a threaded outer surface and means for tightening the locking nut into the handle to secure the handle to a motorcycle handlebar.

2. The handgrip of claim 1, wherein the handgrip is formed without securing members extending radial beyond an outer diameter of the handle.

3. The handgrip of claim 1, wherein the means for tightening the locking nut include at least two radially oriented groves in an end surface of the locking nut.

4. The handgrip of claim 3 in combination with a tightening tool comprising:
a C-shaped tool body with at least two protrusions sized and shaped to extend into the groves in the locking nut; and
a handle connected to the C-shaped tool body.

5. A method of attaching a handgrip to a handlebar, the method comprising:
assembling a handgrip assembly by placing a collet into a handgrip with a tapered outer surface of the collet abutting a tapered inner surface of the handgrip;
threading a locking nut into the handgrip without tightening;
placing the handgrip assembly over a motorcycle handlebar; and
tightening the handgrip in place with a C-shaped tightening tool.
